(19) United States
(12) Patent Application Publication
(10) Pub. No.: US 2023/0002974 A1
(43) Pub. Date: Jan. 5, 2023

(54) COMPOSITIONS AND METHODS FOR MAKING PAPER USING UNCOOKED STARCH FOR GYPSUM PANELS

(71) Applicant: KNAUF GIPS KG, Iphofen (DE)

(72) Inventors: Mark K. HEMPHILL, Hawthorn Woods, IL (US); Gregory K. YUM, Gurnee, IL (US); Yijun SANG, Oak Park, IL (US)

(21) Appl. No.: 17/809,101

(22) Filed: Jun. 27, 2022

Related U.S. Application Data
(60) Provisional application No. 63/217,919, filed on Jul. 2, 2021.

(51) Int. Cl. D21H 19/54; C04B 28/14; D21H 11/02; D21H 17/25

(52) U.S. Cl. CPC D21H 19/54; C04B 28/14; D21H 11/02; D21H 17/25; C04B 2111/0062

(57) ABSTRACT

A gypsum wallboard panel comprises: a gypsum core; and a paper cover sheet disposed on the gypsum core, the paper cover sheet comprising pulp fiber and an uncooked starch in an amount of at least 2% by weight of the pulp fiber.

### REFERENCE TO RELATED APPLICATIONS

The present application claims priority to U.S. Provisional Application Ser. No. 63/217,919, filed Jul. 2, 2021, entitled COMPOSITIONS AND METHODS FOR MAKING PAPER USING UNCOOKED STARCH FOR GYPSUM PANELS. U.S. Provisional Application Ser. No. 63/217,919 is incorporated by reference in its entirety herein.

### FIELD

The present disclosure relates to gypsum structures and components therefor. More specifically, the present disclosure relates to compositions and methods for making paper using uncooked starch for use with gypsum panels such as wallboard panels.

### BACKGROUND

Gypsum (calcium sulfate dihydrate) panels are well-known products. They are used primarily as an interior wall and ceiling product, but also to a certain extent as an exterior product. An example gypsum panel is a wallboard panel, which is widely used in building construction, including walls and other surfaces, and partitions.

To prepare a gypsum panel such as a wallboard panel (wallboard), a stucco slurry including calcium sulfate hemihydrate (stucco or calcined gypsum), water, and other ingredients is combined, e.g., in a mixer, on a wet end of a wallboard production line. This slurry is dispensed between two cover sheets of paper continuously on the wallboard production line. For example, the slurry can be continuously deposited on a first paper cover sheet to provide a continuous strip or ribbon. A second paper cover sheet can be applied thereover, and the resultant (sandwich) assembly can be formed into a desired shape. An example paper for the first paper cover sheet is manila paper.

The calcium sulfate hemihydrate reacts with sufficient water to convert the hemihydrate stucco into a matrix of interlocking calcium sulfate dihydrate crystals, causing it to set and to become firm. The continuous strip or ribbon can be conveyed on a belt until the calcined gypsum is set, or otherwise allowed to set. The strip is cut to form panels, e.g., boards or tiles, of desired length. The boards are conveyed through a dryer such as a drying kiln to remove excess moisture and are output on a dry end of the wallboard production line. Example processes for manufacturing wallboard are described in U.S. Pat. Nos. 6,494,609 and 6,986,812, which patents are incorporated herein by reference.

It is desirable to reduce the density and weight of gypsum panels including wallboard panels. Typically, aqueous foam is added to the stucco slurry. Air bubbles in the aqueous foam reduce the density of the set gypsum core. However, wallboard used in various applications must meet industry standards for nail pull strength, compressive stress, flexural strength, and other requirements, which can be more challenging for lower density boards.

Since the weight of wallboard typically is reduced, various methods have been disclosed to recover nail pull strength loss. For example, pregelatinized starch can be formulated into a wallboard gypsum core. Nail pull strength improvement of 0.3-0.5 lbs per pound pregelatinized starch per msf has been achieved. However, this method is not very efficient with respect to the amount of starch required, and thus undesirably increases production costs. Further, the maximal amount of pregelatinized starch that can be added into the gypsum core is limited to less than 5% due to combustion restriction.

Another known solution for increasing strength of wallboard is increasing paper weight. Manila top liner plies are inherently weak in strength. The high proportions of inert clays and fillers contained in the flyleaf shavings stock constituent subtract from the strength of the liner plies. Moreover, the soft stocks and clays contained in the manila top liner plies are noted for poor dewatering, slow drainage, and slow drying.

However, conventional multi-ply manila paper that is modified to meet the industry requirements in lightweight wallboard is significantly heavier than typical wallboard paper. Manila paper weight of more than 50 lbs/msf has been used, for instance, to manufacture wallboard products. High paper weight not only increases cost, but also limits the paper manufacturing rate. On the other hand, decreasing the weight of paper may render this paper no longer suitable as a cover sheet because the paper no longer meets the requirements for strength and flexibility.

### SUMMARY

There is an opportunity in the art to create more efficient methods to manufacture light weight wallboard having acceptable nail pull strength.

According to one aspect of the disclosed embodiments, a gypsum wallboard panel comprises: a gypsum core; and a paper cover sheet disposed on the gypsum core, the paper cover sheet comprising pulp fiber and an uncooked starch in an amount of at least 2% by weight of the pulp fiber.

According to another aspect of the disclosed embodiments, a multi-ply paper cover sheet comprises a plurality of plies, at least one ply comprising: pulp fiber comprising one or more of hard stock or soft stock fiber; and an uncooked starch in an amount of at least 2% by weight of the pulp fiber.

According to yet another aspect of the disclosed embodiments, a composition for a paper cover sheet comprises: water; pulp fiber comprising one or more of hard stock or soft stock fiber; and an uncooked starch in an amount of at least 2% by weight of the pulp fiber.

According to yet another aspect of the disclosed embodiments, a method for making a paper cover sheet for a wallboard comprises: preparing a composition comprising water and pulp fiber comprising one or more of hard stock or soft stock fiber; incorporating an uncooked starch in an amount of at least 2% by weight of the pulp fiber into the composition; forming at least one ply with the composition; and drying the at least one ply. A method of forming a wallboard panel comprises preparing a paper cover sheet according to the above method; preparing a gypsum slurry comprising stucco and water; forming a gypsum core layer over the prepared paper cover sheet; allowing the gypsum core layer to set; and drying the gypsum core layer.

Other features and advantages of the invention will be apparent from the following specification taken in conjunction with the following FIGURE.

### BRIEF DESCRIPTION OF THE DRAWING

The present disclosure will become more fully understood from the detailed description and the accompanying FIGURE, wherein:

FIG. 1 is a cross-sectional view of an example gypsum panel according to an embodiment of the present disclosure.

### DETAILED DESCRIPTION

Starch, especially cooked starch, has been investigated in enhancing strength in wallboard paper applications. However, only tensile strength improvement has been found. Efforts to increase nail pull strength through the addition of starch into wallboard face paper have failed. In addition, cooked starch is difficult to handle due to its high viscosity. For instance, it is easy for cooked starch, which behaves like a polymer adhesive, to clog the paper machine's forming wire.

Embodiments disclosed herein provide, among other things, a gypsum wallboard panel comprising: a gypsum core; and a paper cover sheet disposed on the gypsum core, the paper cover sheet comprising pulp fiber and an uncooked starch in an amount of at least 2% by weight of the pulp fiber.

Example gypsum wallboard panels exhibit adequate strength, e.g., increased nail pull resistance and/or tensile strength and are manufactured more efficiently than using pregelatinized starch in a gypsum core. Further, example gypsum wallboard panels and paper cover sheets therefor can be reduced in weight while still providing suitable tensile strength and nail pull resistance. Reducing the amount of starch used in the gypsum core can also reduce wallboard production costs. In some embodiments, uncooked starch added at a wet end to prepare wallboard face paper (Manila) increased nail pull strength about 8-10 times as efficiently as adding pregelatinized starch in wallboard core for nail pull strength improvement.

While the paper and wallboard of this invention are capable of being manufactured in embodiments in many different forms, there is shown in the drawing and will herein be described in detail preferred embodiments of the invention with the understanding that the present disclosure is to be considered as an exemplification of the principles of the invention and is not intended to limit the broad aspects of the invention to the embodiments illustrated.

Unless otherwise noted, concentrations used in this description refer to percentages by weight based on the dry weight of stucco (calcium sulfate hemihydrate).

Referring now to the drawing, a multilayer gypsum panel, generally 10, includes a gypsum cementitious core (gypsum core) 12 covered on the face side with a paper cover sheet 14 and on the back side with another paper cover sheet 16. The paper cover sheets 14, 16 are disposed (directly or indirectly) on the gypsum core 12 to cover the face and back sides of the gypsum core.

Panels may include boards or tiles, such as but not limited to wallboards or other surface boards and ceiling tiles. Embodiments and methods will be described herein with reference to wallboard panels, however, reference herein to features of any one of panels, boards, wallboard panels, or tiles are intended to be likewise applicable to features of any of the others, except where explicitly indicated otherwise.

In some embodiments a wallboard panel comprising at least a face paper cover sheet comprising uncooked starch may be prepared with a gypsum slurry. The gypsum slurry may be prepared, for instance, by mixing water with calcined gypsum and various additives, including by methods described in U.S. Pat. No. 7,572,329, incorporated by reference herein, to form the gypsum core 12.

The gypsum panel 10 includes at least two opposing long surfaces (“long” is not intended to require a particular minimum length). During the manufacture of the gypsum panels, a continuous strip of core material can be produced that is cut to form individual panels. For a gypsum panel such as a wallboard panel, one of the long surfaces is typically referred to as a back side, and the other, opposing long surface is typically referred to as a face side. After installation is completed, for instance, the face side of the wallboard panel can be decorated, such as by painting and/or applying wallpaper.

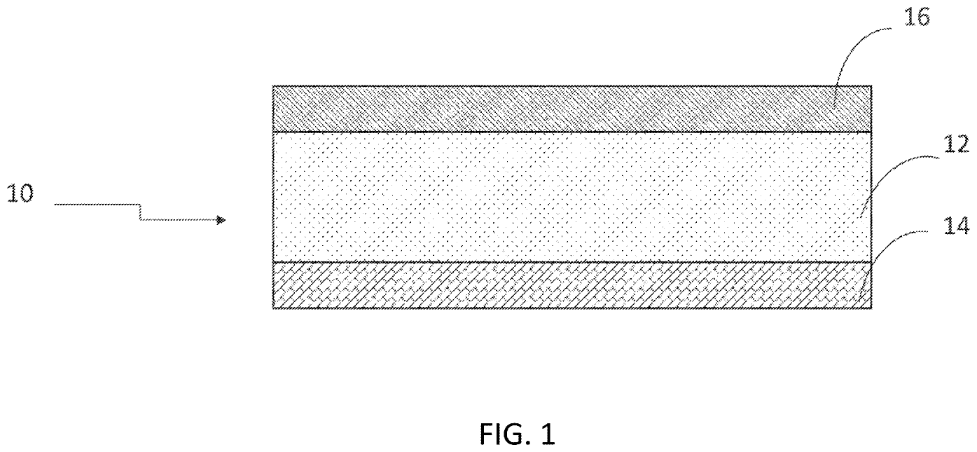

In the embodiment of FIG. 1, the cover sheets 14, 16 are applied directly over the cementitious (gypsum) core 12. In other embodiments, a wallboard panel comprising a cementitious core covered with a paper cover sheet may further comprise additional layer(s), coating(s) and/or component(s) located between either or both of the cover sheets 14, 16, and the cementitious core 12, and/or such additional layer(s), coating(s) and/or component(s) may be applied over the external surface(s) of the paper cover sheet(s).

In embodiments, the gypsum panel 10 includes the facing material 14, 16 embodied in at least one, and preferably two, paper cover sheets. The paper cover sheets 14, 16 cover at least a portion, preferably a majority by area, and more preferably substantially an entirety, of one or both of the long surfaces of the gypsum core 12.

As described, for example, in U.S. Pat. No. 4,959,272, different types of paper may be used for each of the face side 14 and back side 16 cover sheets for a wallboard panel. A first type of paper is typically used as the paper cover sheet 16 on the back side of the wallboard 10 (back side cover sheet, or back paper sheet). This paper can be formed, for instance, from recycled wastepaper having many contaminants, which provides a dark color.

A second type of paper known as manila paper or gypsum wallboard face paper is typically used as a cover sheet 14 on the face side of the wallboard panel (face side cover sheet, or face paper sheet). Manila paper is typically utilized as the face paper of gypsum wallboard, which faces outwardly when the board is mounted on the stud frames. Manila paper provides a light-colored finish, which is desirable for the face paper because it may be covered with relatively few coats of paint without the risk of the underlying color “bleeding” through the paint.

Manila paper can be embodied in, for instance, a multi-ply paper sheet. Materials that may be included in a paper stock composition (or pulp) for manila paper include, but are not limited to, pulp fibers, such as may be provided from recycled Kraft paper, recycled corrugated paper, virgin cellulose fibers, waste newsprint, or any combination thereof. Some example fiber paper stock materials can be referred to generally as hard stock or soft stock, as explained in more detail below. Manila paper may also include inorganics such as calcium carbonate or kaolin. Example paper stock compositions for one or more plies can be composed of a combination (e.g., mixture) of one or more of these materials and other materials described herein.

In some embodiments, the manila paper cover sheet is a multi-ply sheet that includes at least three layers or plies. A center or central filler layer, which can include a combination of one or more layers, can include 50% or more of the pulp fibers. The center layer is combined (e.g., stacked) at one long surface with another filler layer (or multiple filler layers), such as but not limited to a layer of recycled Kraft paper and/or recycled mechanical pulp. On an opposing long surface, the central layer is combined (e.g., stacked) with a liner ply (or multiple top liner plies), such as but not limited to soft stock fibers.

For instance, as described in U.S. Pat. No. 5,945,198, an example multi-ply sheet includes 2 to 7 filler plies composed mainly of hard stock furnishes such as clean wastepaper furnishes such as Kraft clippings or boxboard cuttings of a hard stock nature, and 1 to 2 top liner plies covering the filler plies and composed mainly of soft stock furnishes such as flyleaf shavings and newspapers of a soft, typically mechanical pulp quality to provide a light, manila colored smooth appearance on the face surface (the exposed or decorated side) of the gypsum wallboard.

The flyleaf shavings wastepaper grade can be composed of, for instance, baled trim of magazines, catalogs and similar printed and unprinted material. It can contain mechanical and chemical pulp fibers but may also contain as much as 10-40 percent of clays and pigments from fillers and/or coating overlays. Example components of the 1 to 2 top liner plies which are used to provide a suitable light colored, smooth face appearance can be generally formed of 70-80% by weight of flyleaf furnish, old magazine and trim, and 30-20% waste newsprint.

Another example pulp fiber material that may be used in one or more of the liner and/or filler plies in the manila paper is microfibrillated cellulose (MFC). MFC is a material composed of nanosized cellulose fibrils with a diameter in the range from 4 nm to 100 nm. Various sources of cellulose, which is a naturally occurring polysaccharide polymer, can be used for obtaining MFC, including cellulose obtained from vascular plants. A preferred source of cellulose for obtaining suitable MFC is a wood pulp. MFC may replace amounts of one or more other pulp fibers in the paper stock from which paper plies will be formed. The amount of MFC in the paper ply may be, for instance, 2-10% by dry weight of total pulp fibers in the ply. Example MFC features and use are disclosed in U.S. Pat. No. 10,774,473, which is incorporated by reference herein.

In addition to pulp fibers and possibly other materials, the paper stock includes water that is combined with the pulp fibers and other materials to provide a pulp slurry. For instance, the paper entering a drier may be 45%-60% moisture (e.g., water) by weight based on running parameters.

The paper stock may also comprise a sizing agent, a buffer, and/or other additives. Specific examples of a sizing agent include iso-octadecenyl succinic acid anhydride, n-hexadecenyl succinic acid anhydride, dodecenyl succinic acid anhydride, dodecyl succinic acid anhydride, decenyl succinic acid anhydride, octenyl succinic acid anhydride, nonenyl succinic acid anhydride, triisobutenyl succinic acid anhydride, capryloxy succinic acid anhydride, heptyl glutaric acid anhydride, and benzyloxy succinic acid anhydride, as provided in U.S. Pat. No. 4,853,085. Other sizing agents may be used as well.

Various additives may be used in a paper stock that improve solubilization of a sizing agent and its adhesion to fibers. Such additives include, but are not limited to, alum, aluminum chloride, long chain fatty amines, sodium aluminate, thermosetting resins and polyamide polymers and various cationic starch derivatives including primary, secondary, tertiary, or quaternary amine starch derivatives, as provided in U.S. Pat. No. 4,853,085.

To improve nail pull resistance (strength) of the gypsum panel 10, uncooked starch is incorporated into face paper 14. In some embodiments, the uncooked starch can be added to the paper stock from which paper plies will be formed. Uncooked starch, for instance, can be added to a paper stock of manila paper for at least one filler ply and/or for at least one liner ply.

Alternatively or additionally, the uncooked starch may be added to previously-formed paper plies. Uncooked starch, for instance, can be added to a paper stock of manila paper for at least one filler ply and/or for at least one liner ply. One or more filler plies may be provided in some embodiments by the central layer described above.

In some methods, uncooked starch may be combined with a liquid such as water and then dispersed, e.g., sprayed, onto one or more of the central layer and/or the at least one liner ply. For instance, the uncooked starch may be dispersed over the central layer and the at least one liner ply just before the two plies combine, e.g., after water from the slurry migrates (e.g., drains) through the plies.

In some embodiments, the uncooked starch after being combined with water may be heated to a temperature above ambient temperature but below the pregelatinization temperature of the uncooked starch. This allows the water to more easily penetrate the starch granules.

Surprisingly and unexpectedly, the incorporation of uncooked starch in paper cover sheets for gypsum panels has been found to increase nail pull resistance (strength) in the complete gypsum panel much more efficiently than, for instance, adding pregelatinized starches to a gypsum slurry for forming a set gypsum core. Without wishing to be bound by theory, the incorporated uncooked starch is believed to significantly improve tensile strength of the cover sheet paper, enhancing nail pull resistance of the gypsum panel by a significantly greater amount than incorporation of an equivalent amount of starch, e.g., cooked or pregelatinized starch, to the gypsum core.

While some papermaking methods incorporate a small amount (less than 2% by dry weight of pulp fiber) of cooked (pregelatinized) starch into paper stock, the amount of such cooked starch that can be added to paper stock is significantly limited, as it results in unacceptable viscosity and possible clogging of equipment. By contrast, cover sheet paper according to embodiments herein can include uncooked starch in significantly greater amounts if desired, e.g., between 2%-10% by dry weight of pulp fiber, or greater. This is believed to provide a significantly higher level of strength enhancement to the cover sheet paper, and to the gypsum panel having the cover sheet paper.

For instance, the strength of the improved gypsum board (e.g., nail pull resistance and tensile strength) may be increased by an amount between about 6 lbs and about 8 lbs of nail pull strength, and/or a 20% to 40% increase of tensile strength as compared to equivalent gypsum boards without the uncooked starch in the paper cover sheet. The density/weight of the paper cover sheet may be reduced by, for instance, 6 to 10 lbs per msf.

Starches are carbohydrates containing two types of polysaccharides: linear amylose and branched amylopectin. Starches generally are known in the art to be added to a stucco slurry for binding a resulting gypsum panel core to facing materials described herein and/or to enhance compressive strength of the final product. For instance, since starch contains glucose monomers containing three hydroxy groups, starch can provide multiple sites for hydrogen bonding to gypsum crystals. Nonlimiting strength enhancing starches include native and/or modified starches.

Starches can be classified as either cooked or uncooked. Uncooked refers to the starches being in granular form. Uncooked starches are cold water insoluble and have a semi-crystalline structure. Starch granules are semicrystalline, e.g., as seen under polarized light, and are insoluble at room temperatures. By contrast, in cooked starches (also referred to as pregelatinized starches), the starch is placed in water and heated (or cooked) so that the crystalline structure of the starch granules melts and dissolves in water (gelatinization). One of ordinary skill in the art will appreciate methods of pregelatinizing raw starch, such as, for example, cooking raw starch in water at temperatures of at least about 185° F. (85° C.) or other methods. “Uncooked” as used herein means that the starch has a degree of gelatinization of less than about 5% (e.g., less than about 3%, or less than about 1%, or about zero) before being incorporated into the paper (e.g., added to the paper stock or to formed paper plies). Gelatinization can be determined, e.g., by the disappearance of birefringence under a microscope with a polarized light.

Some example uncooked starches can be provided, for instance, by wet milling. Example uncooked starches include cereal starches, root starches, and tuber starches, such as but not limited to corn starch, wheat starch (e.g., A type, B type), pea starch, tapioca starch, or potato starch. Starches may be native starches, and chemically modified starches (e.g., acid-modified substituted starches having substituted groups, or a combination.

The uncooked starch can be used in various amounts. In some embodiments, uncooked starch is used in an amount from about 1% to 10% by dry weight of the pulp fiber total in a paper or pulp stock (dry pulp basis) (2.5 lb/msf), e.g., in a range having a lower bound of 1%, 2%, 3%, 4%, 5%, 6%, 7%, 8%, 9%, or 10%, and an upper bound that is greater than the lower bound of, 10%, 9%, 8%, 7%, 6%, 5%, 4%, 3%, or 2%.

The uncooked starch may be introduced in place of paper pulp, or may be simply added to an existing manila paper composition. The inclusion of uncooked starch in the manila paper can reduce manila paper weight, overall wallboard weight, and/or wallboard manufacturing cost, while surprisingly and unexpectedly providing enhanced nail pull strength at least comparable to conventional methods that add pregelatinized starch to a wallboard core.

The uncooked starch may be cationic, anionic, or uncharged. While cooked starches are more dependent on their charge for retention to paper, uncooked starches may be more dependent on physical properties (e.g., size) for such retention. While uncooked cationic starch may provide improved pulp stock retention in some applications, anionic or uncharged uncooked starches are suitable for incorporating into paper cover sheets. An example uncooked starch size is between about 10 μm and about 50 μm.

A nonlimiting example uncooked anionic starch is Ecosol 45. Other example uncooked cationic or uncharged starches include CATO™ 232, STA-LOK™ 160, and OPTIPRO™ 650.

In some embodiments it may be useful to partially pre-cook the uncooked starches, e.g., at a temperature below the starches' gelatinization temperature before introducing the uncooked starch. This may be done, for instance, to ensure complete gelatinization of the uncooked starch in the paper cover sheet when the paper is dried during a wallboard manufacturing process. If the drying process is too short, or at too low a temperature, or if insufficient moisture is present, the uncooked starches may not fully gelatinize and thus may not provide optimal strength enhancement to the paper cover sheet and gypsum panel. “Complete gelatinization” refers to a gelatinization of at least 50% by weight of the uncooked starch that is introduced into the paper.

Paper stocks formulated with uncooked starch may be used for forming and pressing paper plies, including filler plies, liner plies, or a combination of paper and filler plies. Several plies formulated with uncooked starch may be pressed together if a multi-ply paper sheet is to be produced. In some embodiments, paper plies including uncooked starch may be pressed together with paper plies which do not include uncooked starch to produce a multi-ply paper sheet. In some embodiments, some or all filler plies include uncooked starch, and they are pressed together with at least one liner ply which does not comprise uncooked starch to obtain a multi-ply paper sheet. In some embodiments, some or all filler plies do not include uncooked starch, and they are pressed together with at least one liner ply which does include uncooked starch to obtain a multi-ply paper sheet.

Reference to paper cover sheets comprising uncooked starch may thus refer to paper cover sheets having one or more plies in which any one or more of the plies include uncooked starch, even if others of the plies do not include uncooked starch. Paper cover sheets may include multi-ply and single-ply cover sheets.

Other paper grades may be used, such as but not limited to newsline, sheathing, paper for plaster application and water-resistant paper for high humidity applications. These paper grades may be prepared, for instance, by optionally adding uncooked starch to paper stocks and following conventional paper making protocols including those described in U.S. Pat. No. 4,853,085.

In some paper formation methods, one or more paper stocks (pulp stocks) with pulp fibers are prepared for at least one ply. For multi-ply paper cover sheets, the one or more paper stocks with pulp fibers are prepared for a filler ply, and other, separate paper stocks may be prepared for one or more liner plies. The paper stock for each ply includes water, pulp fiber, and optionally one or more additives. The paper stock for at least one ply may include water, pulp fiber, an uncooked starch if such starch is to be added to the paper stock, and optionally one or more additives. Pulp fibers may include, but are not limited to, those typically used in a gypsum board paper cover sheet. Nonlimiting example pulp fibers include recycled Kraft paper, recycled corrugated paper, virgin cellulose fibers, waste newsprint, or any combination thereof.

In some paper formation methods, which may be used in combination with the above paper formation methods, one or more paper stocks with pulp fibers are prepared for at least one ply. For multi-ply paper cover sheets, one or more paper stocks with pulp fibers are prepared for one or more filler plies, and other, separate paper stocks may be prepared for one or more liner plies. The paper stock for each ply includes water, pulp fiber, and optionally one or more additives. The paper stock for at least one ply may include water, pulp fiber, an uncooked starch, and optionally one or more additives. After one or more plies are formed, uncooked starch may then be added to one or more of these plies, such as by spraying or otherwise dispersing a composition of the uncooked starch in water onto a surface of one or more of the plies. The sprayed uncooked starch composition can migrate through one or more of the plies, e.g., a ply having a surface on which the uncooked starch composition is sprayed, and possibly one or more underlying plies, to incorporate the uncooked starch into the plies.

In some embodiments, uncooked starch may be combined with the water and then dispersed, e.g., sprayed, onto one or more of the central layer and the at least one liner ply. For instance, the uncooked starch may be dispersed over the central layer and the at least one liner ply just before the two plies combine, e.g., after water from the slurry migrates (e.g., drains) through the plies. In some embodiments, the uncooked starch combined with water may be preheated to a temperature above ambient temperature but below the gelatinization temperature of the uncooked starch to allow the water to penetrate the starch granules. An example preheating temperature is between 40° C. and 60° C. This can improve gelatinization of the uncooked starches when the paper is dried.

A multi-ply paper can be prepared by pressing several plies together such that a liner ply is the most outer ply overlaying a filler ply. Various paper grades, including manila paper, may be prepared by this method. The manila paper may include several, e.g., 1 to 8, filler plies along with one to two liner plies as the top layers facing outwardly when the board is mounted. Example filler and liner plies in the manila paper may include, for instance, one or more of the following pulp fibers: Kraft clippings, waste newsprint, recycled corrugated paper, or MFC. If MFC is used, it may be used in an amount from 2% to 10% by dry weight of the pulp fibers total, and preferably from 4% to 10% by dry weight of the pulp fibers total.

The material for the back side cover sheet 16 may be the same as that for the face side cover sheet 14 or may be other material such as conventional wallboard facing material, examples of which include manila paper or kraft paper, non-woven glass, metallic foil, or combinations thereof. An example of a non-woven glass facing material is Johns Manville Dura-Glass Mat Series 5000 (Denver, Colo.).

Where paper is selected as a back face facing material 16, multi-ply paper, such as conventional wallboard paper, may be useful. The number of plies optionally varies, e.g., from 1-9 plies, depending on the paper chosen. For example, at least one backing sheet may face an outer surface of the gypsum core 12 such as the back face. The backing sheet 16 may be disposed directly on the gypsum core 12, or indirectly, with one or more additional layers disposed between the gypsum core and the backing sheet.

Other facing materials may also be suitable including but not limited to polymer sheets and sheeting made of reinforcing fibers, such as fiberglass.

The panel core 12 includes gypsum, also known as landplaster, terra alba, or calcium sulfate dihydrate, and thus can be referred to as a gypsum core. Gypsum cores according to embodiments are made from a gypsum slurry that includes calcium sulfate hemihydrate and water.

Gypsum is made into the panel 10 by adding water to stucco, also known as plaster of Paris, calcined gypsum, or calcium sulfate hemihydrate, to form the slurry. The calcium sulfate hemihydrate is hydrated with water to form an interlocking matrix of calcium sulfate dihydrate crystals. Calcined gypsum including calcium sulfate hemihydrate, calcium sulfate anhydrite, or both can be used in example slurries.

Calcium sulfate hemihydrate can produce at least two common crystal forms, the alpha and beta forms. Beta calcium sulfate hemihydrate is commonly used in gypsum board panels, but it is also contemplated that panels made of alpha calcium sulfate hemihydrate or mixtures of alpha and beta hemihydrate could be used. Beta-calcined stucco is provided as a preferred calcium sulfate hemihydrate in some example slurries. In some embodiments, anhydrite gypsum is also contemplated for use as a minor component of calcined gypsum, for instance in amounts of less than 20% by weight of the calcined gypsum content in the slurry.

In some embodiments, the gypsum core includes at least 50% calcium sulfate hemihydrate by weight of the dry components. In some embodiments, the gypsum core can include at least 60% calcium sulfate hemihydrate and even more preferably from 70-99% by weight. In some embodiments, the amount of stucco in the gypsum core is from about 70 to about 90 wt % based on the weight of the dry solids.

The gypsum core further includes water. During manufacture of the gypsum articles, the water is present as a liquid. The stucco and the shrink-resistant material are added to the water to form a slurry.

The stucco or gypsum slurry may be formed, for instance, inside a mixer such as but not limited to a pin or pinless main mixer during a manufacturing process. However, the mode of introduction of ingredients into the mixer may vary. For example, various combinations of components may be pre-mixed before entering the mixer, e.g., one or more dry ingredients and/or one or more wet ingredients may be pre-mixed. By “added to,” or “included in” it will be understood that ingredients may be pre-mixed in any suitable manner prior to entry into the mixer where the stucco slurry is formed as set forth herein. A mixer can be embodied in one or multiple mixers, and references herein to a mixer can likewise refer to multiple mixers.

The stucco slurry includes the calcium sulfate hemihydrate (stucco), water, and optionally one or more additional components as discussed in more detail below. Stucco may be added to the stucco slurry in an amount that is, as a nonlimiting example, between about 80% and about 90% by weight of the total solids in the stucco slurry.

Optional reinforcing fibers can be added to the stucco slurry, e.g., in an amount of 0.5% or more by weight of the dry stucco. In some embodiments, reinforcing fibers can be added in an amount between about 0.5% and about 20% by weight of the dry stucco. For instance, the reinforcing fibers may be added to the stucco slurry in an amount by weight of the dry stucco having a lower bound that is at least about 0.5%, 1.0%, 2.0%, 4.0%, 6.0%, 8.0%, 10.0%, 12.0%, 14.0%, 16.0%, 18.0%, or 20.0%, with an upper bound that is greater than the lower bound and is at most about 20.0%, 18.0%, 16.0%, 14.0%, 12.0%, 10.0%, 8.0%, 6.0%, 4.0%, 2.0%, or 1.0%.

The size of the reinforcing fibers may be selected to optimize strength. Example long reinforcing fibers are from about ¼″ in length to about 1 inch. If the fibers are too short, they may not impart sufficient strength to the panel that is desired. If the fibers are too long, they may build up in a mixer during manufacture. Some natural fibers, such as cellulose, may be limited in size. They can be considered reinforcing fibers if they are longer than average for that fiber type. However, in such cases, the product strength may not be as optimal as products using manufactured fibers that can be made in the example range between ¼″ in length to about 1 inch in length.

In some embodiments glass fibers (normally ½″-¾″ in length and 10-16 microns in diameter with melting point above 800° C.) may be added into the gypsum core to reinforce the gypsum panel, e.g., by keeping the whole gypsum panel together (or hold the integrity) after both facing papers are burned off under a fire. Other example reinforcing fibers include carbon fibers, alumina trihydrate (ATH) fibers, etc.

In some embodiments, one or more additives are optionally included in the gypsum slurry. Example additives include, but are not limited to, accelerators, dispersants, retarders, and additional strength enhancers (i.e., in addition to the uncooked starch incorporated in the paper cover sheet(s) as disclosed herein).

An example strength enhancer that may be used in example gypsum panels is starches, including uncooked starches and cooked (pregelatinized) starches. Examples of uncooked starches for the gypsum slurry can include one or more of the uncooked starches discussed above.

In addition to uncooked starches, including pregelatinized starch in the gypsum slurry can increase the strength of the set and dried gypsum cast (e.g., provide increased nail pull resistance). Further, it can minimize or avoid the risk of paper delamination under conditions of increased moisture (e.g., with regard to elevated ratios of water to calcined gypsum). Examples of pregelatinized starch include, but are not limited to, PCF 1000 starch, commercially available from Bunge Milling Inc. and AMERIKOR 818 and HQM PREGEL starches, both commercially available from Archer Daniels Midland Company. Other example pregelatinized starches are disclosed in U.S. Pat. Pubs. 2014/0113124A1 and 2015/0010767A1, which are incorporated by references herein.

Uncooked starch granules may be combined in the stucco slurry with cooked (gelatinized) starches. For instance, additional starch may be added to the stucco slurry for use as a binder during hydration of the stucco. Example pregelatinized starches that may be used for binders are provided in U.S. Pat. App. Pub. No. 2019/0023612, which is incorporated by reference.

If included in the gypsum slurry, the starch may be present in any suitable amount. In some embodiments, if included, the starch is added to the stucco slurry such that it is present in an amount of from about 0.1% to about 5% percent by weight of the stucco, for instance within a percentage range having a lower bound of 0.1, 0.5, 1.0, 2.0, 3.0, 4.0, 5.0, and an upper bound of 5.0, 4.0, 3.0, 2.0, 1.0, or 0.5.

Properties of the gypsum core can optionally be modified by the inclusion of other additives in the stucco slurry. For instance, set retarders or accelerators may be added to modify the rate at which hydration takes place.

Example set accelerators, e.g., wet gypsum accelerator, heat resistant accelerators, climate stabilized accelerators, etc., may be provided in the stucco slurry in amounts such as between about 0.1% and about 10% by weight of the dry stucco.

An example gypsum set accelerator includes 95% calcium sulfate dihydrate co-ground with 5% sugar and heated to 250° F. (121° C.) to caramelize the sugar and can be made according to U.S. Pat. No. 3,573,947, herein incorporated by reference. Another typical gypsum set accelerator is calcium sulfate dihydrate freshly ground with sugar or dextrose at a ratio of about 2.5 to 7.5 pounds of sugar per 100 pounds of calcium sulfate dihydrate and can be made according to U.S. Pat. No. 2,078,199, herein incorporated by reference. The use of any gypsum set accelerator, or combinations thereof, in appropriate amounts is contemplated for use in embodiments.

The stucco slurry may further comprise a retarder. For instance, salts and organic compounds are known to modify a set time of a slurry, varying widely from accelerating to retarding gypsum hydration. Example retarders include a 1% solution of pentasodium salt of diethylenetriaminepentaacetic acid (Versanex™ 80, commercially available from Dow Chemical Company, Midland, Mich.). Some example retarders are disclosed in U.S. Pat. Nos. 3,573,947 and 6,409,825.

The retarder may be added to the stucco slurry, as a nonlimiting example, in an amount on a solid basis of about 0.1% to about 10.0% by weight based on the dry weight of the stucco.

Binders may optionally be added to the stucco slurry to improve the integrity of the gypsum core. Binders may also be provided in some embodiments to improve bonding of the gypsum core to a facing material.

Example binders include starches, such as corn or wheat starch, a latex, such as polyvinyl acetate, acrylic, or styrene butadiene latexes, or combinations thereof. One example useful binder is an acrylic binder that forms a self-linking acrylic emulsion, such as RHOPLEX HA-16, available from Rohm and Haas (Philadelphia, Pa.). Acrylic binders are optionally used in amounts of from about 0.5% to about 5%, and in some examples from about 0.8% to about 1.5%, by weight of the dry stucco.

Either migrating or non-migrating starches may be useful. Non-migrating starches are also applicable by solution directly to a backing layer (e.g., paper) to enhance bonding with the set gypsum core. Examples of pregelatinized, non-migrating starches useful for a gypsum layer include GemGel Starch (Manildra Group USA, Shawnee Mission, Kans.) and PCF1000 (Bunge North America, St. Louis, Mo.). Examples of non-pregelatinized (uncooked), non-migrating starches include Minstar 2000 and Clinton 106 Corn Starch, acid-modified corn starch Clinton 260 (from Archer Daniels Midland Co., Decatur, Ill.). Examples of migrating starches include Hi-Bond Starch and LC-211 starch (both from Archer Daniels Midland Co., Decatur, Ill.).

In some examples, binders may be provided in the stucco slurry in amounts less than about 4% by dry weight of the stucco, such as between about 0.5% and about 3% by dry weight of the stucco.

Dispersants or surfactants are common additives to modify the viscosity or surface properties of the slurry. For example, another optional component of the stucco slurry is a water reducing agent or dispersant that enhances the fluidity of the slurry and makes it flowable when less water is added. Naphthalene sulfonates, melamine compounds, and polycarbonates are example water reducing agents that may be included in the slurry. In some embodiments, at least 0.5% dispersant is used. Dispersants may be added in dry form (and may be combined with other dry ingredients) or liquid form (and may be combined with other liquid ingredients). Where the water reducing agent is added in the form of a liquid, amounts can be calculated based on the dry solids weight.

If naphthalene sulfonates are used, some embodiments can use those with molecular weights in the range of about 3,000 to about 27,000 Daltons. Example water reducing agents include (Coatex (Arkema), DILOFLO GW (GEO Specialty Chemical, Lafayette, Ind.), and EthaCryl 6-3070 (Lyondell Chemical Co., Houston, Tex.). Example polycarbonates include those having a comb structure with polyalkyl ethers, such as MELFLUX 1641, 2641, or 2651F dispersants, which are products of BASF Construction Polymers, GmbH (Trostberg, Germany) and are supplied by BASF (Kennesaw, Ga.). Other example dispersants include lignosulfonates (water-soluble anionic polyelectrolyte polymers), such as Marasperse C-21 (Reed Lignin, Inc.).

Water reducing agents or dispersants may be provided in the stucco slurry in amounts such as, as nonlimiting examples, between about 0.01% and about 5% by weight of the stucco, and in some examples between about 0.05% and about 1.0% by dry weight of the stucco.

Example water resistance additives include wax emulsions or various siloxanes known in the art, which may be added to the gypsum slurry to improve the water-resistance of the gypsum panel. Example surfactants may be included in the gypsum slurry in amounts up to, e.g., 20 gal./MSF (0.8 l/m²).

Pyrithione salts are useful in addition to other biocides known in the art, and may be used together with any other additives. Pyrithione salts, for instance, are useful when combined with any additives added to the gypsum core slurry to modify other properties of the set gypsum core.

The stucco slurry may optionally include a strength-enhancing agent such as a sagging-resistant agent to enhance the strength of the product and to reduce sag resistance of the set gypsum. The sagging-resistant agent can promote green (wet) strength, dry strength, and/or dimensional stability. Example sagging-resistant agents may include organic acids.

An example sagging-resistant agent is a trimetaphosphate compound, an ammonium phosphate having 500-3000 repeating units, and a tetrametaphosphate compound, including salts or anionic portions of any of these compounds. Some example strength-enhancing agents are disclosed in U.S. Pat. Nos. 6,342,284, 6,632,550, 6,815,049, and 6,822,033, herein incorporated by reference. Exemplary trimetaphosphate salts include sodium, potassium or lithium salts of trimetaphosphate, such as those available from Astaris, LLC., St. Louis, Mo. In some embodiments, a sagging-resistant agent includes sodium trimetaphosphate (SMTP). Boric acids, tartaric acids and combinations thereof also can be used as sagging resistant agents, as is known in the art.

The strength-enhancing agent, e.g., sagging-resistant agent, can be used in any suitable amount, for example, up to about 1%, up to about 0.3%, or from about 0.004% to about 2% by weight based on the dry weight of the ingredients, or from between about 0.01% and about 0.5% by dry weight of the stucco.

To form the stucco slurry, a dry mixture of the dry ingredients may be combined including calcium sulfate hemihydrate (stucco) and optionally one or more additional dry ingredients, examples of which are disclosed herein. The dry ingredients can be blended, e.g., in a mixer such as but not limited to a powder mixer. In some embodiments, dry components other than stucco may be distributed over the dry stucco as it moves along a conveyor, similar to gypsum board production.

The dry components may be added in a slurry mixer to water and/or to a wet mixture including water and one or more optional wet ingredients to obtain the stucco slurry. Wet ingredients, if present, may be added directly to the water. For instance, water may be provided in stucco slurries in a water to solid ratio (by weight) between about 0.30 and about 1.50). For instance, the water to solid ratio may have a lower bound that is at least about 0.30, 0.35, 0.40, 0.45, 0.50, 0.55, 0.60, 0.65, 0.70, 0.75, 0.80, 0.85, 0.90, 0.95, 1.00, 1.05, 1.10, 1.15, 1.20, 1.25, 1.30, 1.35, 1.40, 1.45, or 1.50, in combination with an upper bound that is greater than the lower bound and at most about 1.50, 1.45, 1.40, 1.35, 1.30, 1.25, 1.20, 1.15, 1.10, 1.05, 1.00, 0.95, 0.90, 0.85, 0.80, 0.75, 0.70, 0.65, 0.60, 0.55, 0.50, 0.45, 0.40, or 0.35. The dry and wet components can be mixed, and dispensed in a continuous fashion.

Sufficient water can be added to make a flowable slurry. An example water-to-solid ratio for hydrating the calcined gypsum can be determined based on the weight of the water compared to the weight of the total solids in the formulation. An optimal amount of water may also be determined, at least in part, by the type of calcined gypsum that is used. For instance, alpha-calcined stucco uses less water to achieve the same flowability as beta-calcined stucco. A water to solid ratio in stucco slurries ranges from about 0.6:1 to about 1.2:1. If the calcined gypsum is primarily a beta hemihydrate, the water to solid ratio may be, for example, from about 0.7:1 to about 2:1, and in some examples from about 0.9:1 to 1.5:1.

In some embodiments, the dry components (e.g., all or a portion of the dry components) can be blended in a mixer, e.g., powder mixer, to provide a dry mixture prior to addition to the water or wet mixture. All or a portion of the liquid ingredients, if any, can be added directly to the water or wet mixture before, during, or after addition of the dry components. For example, the liquid ingredients can be added to the water to form a wet mixture, which can then be combined with the dry mixture in the slurry mixer to provide the stucco slurry. As another example, water may be combined with the dry mixture, and during or after combining with the water, the liquid ingredients can be added in the slurry mixer to provide the stucco slurry.

The process water will affect the properties of both the slurry and the set gypsum matrix. Salts and organic compounds are well known to modify the set time of the slurry, varying widely from accelerating to retarding gypsum hydration. Some impurities lead to irregularities in the structure as the interlocking matrix of dihydrate crystals forms, reducing the strength of the set product. Good quality water without contamination can be used to improve product strength and consistency. However, possibly lower-quality water, such as but not limited to tap water, can also be used, and example high-salt gypsum boards are provided in embodiments.

Aqueous foam can be added to the stucco slurry to provide an air-foamed stucco slurry. Air bubbles in the aqueous foam reduce the density of the set gypsum core. The aqueous foam can be provided by combining a foaming agent with water and air. For instance, the foaming agent, water, and air can be combined in a foam mixing apparatus, such as a foam generator.

In some embodiments, an aqueous foam may be generated separately, e.g., pre-generated, by combining a foaming agent with water and air, for instance in a foam generator, and then the aqueous foam can be combined with the stucco slurry downstream of the slurry mixer, e.g., at a discharge of the slurry mixer.

For instance, aqueous foam can be added to, e.g., injected into, the stucco slurry as it exits (discharges from) the slurry mixer or thereafter to provide fluidity to the mix. In other embodiments, the aqueous foam can be combined in situ. For instance, the foaming agent can be added to the stucco slurry in the slurry mixer, where high shear agitation or mixing generates bubbles. Methods for combining stucco slurries with aqueous foam are disclosed in U.S. Pat. Nos. 5,643,510, 6,494,609, and 7,851,057, each of which is incorporated by reference herein. Other methods for combining stucco slurries with aqueous foam may be used, as will be appreciated by those of ordinary skill in the art.

Conventional foaming agents known to be useful in gypsum products may be added to the aqueous foam. An example foaming agent is a surfactant such as stable soap. Other surfactants such as unstable soaps can be added to the aqueous foam in addition to the stable soap. Example foaming agents include alkyl ether sulfates and sodium laureth sulfates, such as STEOL® CS-230 (Stepan Chemical, Northfield, Ill.), foaming agents, such as but not limited to the HYONIC line (e.g., 25AS) of soap products, available commercially from GEO Specialty Chemicals in Ambler, PA, POLYSTEP B25 (Stepan Company, Northfield, Ill.), and others disclosed in, for example, U.S. Pat. Nos. 4,676,835; 5,158,612; 5,240,639; and 5,643,510, 5,683,635, as well as in PCT Intl. Pub. WO 95/16515 (Jun. 22, 1995).

The foaming agent can be added to the aqueous foam in an amount sufficient to obtain the desired density in the set gypsum core. For example, the foaming agent may be present in amounts of about 0.003% to about 2.0%, and in some examples from about 0.005% to about 1.5% by weight, based on the weight of the dry stucco.

Optionally, a foam stabilizer may be added to the air-foamed stucco slurry in a suitable amount. Example foam stabilizers are disclosed in U.S. Pat. No. 7,851,057, which is incorporated by reference herein.

The foaming agent and the water can be combined (e.g., mixed) to provide a foaming agent solution in the aqueous foam. For example, an example aqueous foam can include a foaming agent solution having a foaming agent concentration of, as a nonlimiting example, between about 0.5% and about 2.5% by weight. Some example foaming agent solutions include a 1% soap solution (stable soap, unstable soap, or a combination of stable and unstable soap). A combination of stable soap and unstable soap, for instance, can be used to control the amount of air added and the size of the air bubbles. The water in the foaming agent solution may be any suitable water, e.g., filtered water, tap water, etc. In some embodiments, the combined water in the air-foamed slurry, including the water from the stucco slurry and the additional water in the foaming agent solution, can be provided in a water to stucco ratio between about 60% and about 150% by weight. For instance, the water to stucco ratio (by weight) may have a lower bound that is at least about 60%, 70%, 80%, 90%, 100%, 110%, 120%, 130%, or 140%, in combination with an upper bound that is greater than the lower bound and at most about 150%, 140%, 130%, 120%, 110%, 100%, 90%, 80%, or 70%.

To provide air-foaming with stable air bubbles, an example aqueous foam includes a mixture of air and the foaming agent solution, such as but not limited to a stable soap solution. The air rate and flow rate can be selected to provide an optimal air bubble size and air bubble proportion in the air-foamed stucco slurry. The air rate and/or flow rate can be adjusted according to a target core density, as will be appreciated by those of ordinary skill in the art. The amount and/or type of foaming agent used can affect how much air is incorporated into the set gypsum core.

In some methods, no additional mixing is necessary after foam addition. The foam and slurry can mix sufficiently as it moves, e.g., through one or more hoses and conduits, to a forming table.

The gypsum panel may further include one or more additional layers, such as but not limited to a skim coat, a densified layer, a concentrated layer, or other enhanced layer. The additional layer, if provided, can be positioned between the gypsum core 12 and the facing material 14, 16. In some embodiments, the additional layer(s) include(s) set gypsum and one or more additives, one or more of which may be provided in greater concentrations that those in the gypsum core. Example concentrated layers are disclosed in U.S. patent application Ser. Nos. 15/186,176; 15/186,212; 15/186,232; and Ser. No. 15/186,257.

If additional layers are provided in the gypsum panel 10, it is contemplated that the gypsum slurry may be divided into at least two portions, e.g., a primary and secondary portion, as the slurry is discharged from the mixer, e.g., as it exits or immediately after the exit. The aqueous foam may then be pumped into at least one of the slurry streams, e.g., a primary portion, that will form the gypsum core 12, and the slurry and the foam stream can then be moved downstream to become the gypsum core. Another slurry stream can then be used to prepare the additional layer(s). Nonlimiting examples of additional layers and coatings are disclosed in PCT Application PCT/US2020/036608 (Intl. Pub. No. WO 2020/256980A1), incorporated by reference herein.

The prepared air-foamed slurry can provide a composition that can be formed into a (gypsum precursor or precursor) core using a casting process. In an example casting process, after the aqueous foam is added to the slurry (or at least a portion thereof) to provide (at least a portion of) the air-foamed slurry, the air-foamed slurry can be discharged to a moving conveyor and onto the facing material to provide a gypsum core for a gypsum panel. Example board manufacturing methods are disclosed in U.S. Pat. No. 7,364,676 and U.S. Pat. App. Pub. 2010/0247937, which are incorporated herein by reference.

An example casting method in some embodiments can be a batch process. In other embodiments the casting method may be an individual process.

In an example casting method, an air-foamed slurry is prepared for a set gypsum core as described above. In some methods, one or more optional liquid materials, e.g., dispersant, retarder, sagging-resistant materials, etc., may be pre-mixed in, for instance, a slurry mixer with water to provide a wet mixture and then combined with the dry mixture, e.g., including stucco and optional dry materials such as reinforcing fibers, set accelerators, etc., prepared in, for instance, a powder mixer, to provide the stucco slurry. The aqueous foam, e.g., from a combination (e.g., mixture) of water, air, and the foaming agent, can be pregenerated, e.g., in a foam generator, and added to the slurry, e.g., at the discharge of the mixer, to provide an air-foamed slurry. The mixing time for the stucco slurry and the air-foamed slurry should be sufficient to yield a uniform slurry, but less than the set time of the slurry.

In other methods, the wet mixture can be mixed with the aqueous foam (pregenerated or mixed in situ) to form a process solution. The process solution can then be combined with the dry mixture to provide the air-foamed slurry.

If an optional additional layer is to be provided, the stucco slurry may be divided into a main stream and a slip stream, and then both the stucco slurry in the main stream and the slip stream can be combined with the aqueous foam, or alternatively one or more of the additional layers may be kept separate from or otherwise not combined with the aqueous foam.

The gypsum slurry is continuously deposited on a first paper cover sheet moving (directly or indirectly) on a conveyer belt beneath a mixer to form a continuous strip. The first paper cover sheet comprises uncooked starch, e.g., as provided in methods herein. The first paper cover sheet is fed, e.g., from a roll. For example, the wet slurry mixture may be dispersed, e.g., poured using a flexible conduit, from the mixer containing the wet slurry mixture (e.g., a slurry mixer), combined with the aqueous foam to form an air-foamed slurry. The air-foamed slurry may then be spread evenly onto the first paper cover sheet, which is positioned on the conveyor belt to receive the slurry. In some embodiments, the gypsum slurry can be made sufficiently fluid so that it will spread over the surface of the backing material with little or no spreading necessary.

If a facing material is applied to an opposing long surface, it can be applied while the gypsum slurry is still fluid, sandwiching the slurry between the two facing materials. For instance, a second paper cover sheet may be applied over the gypsum slurry, e.g., fed from a second roll. The second paper cover sheet may also comprise uncooked starch in some embodiments, e.g., as provided in methods herein. Other facing layers may be provided, such as backing sheets, scrim layers, etc. A nonlimiting example facing material is glass-mat. The gypsum core, and covering materials, if present, can pass under a forming bar to make the gypsum core a uniform thickness. The resultant assembly can be formed into the shape of a panel strip which is covered on one or both of the two long surfaces with a paper cover sheet.

The continuous strip forms the gypsum core layer when set. Once the panel strip sets and becomes firm, it may be cut to form wallboards of desired length. Typically, the wallboards are conveyed through a drying kiln to remove excess moisture. For instance, when the gypsum core has set sufficiently to achieve desired green strength to be easily handled, the gypsum product, can be cut and transferred (e.g., using a conveyor) to a heater such as but not limited to a kiln for heating and drying. The kiln may optionally include multiple zones to achieve selected heating and drying conditions. Alternatively, multiple heaters and dryers may be used, e.g., in series, with the gypsum product being transferred among the multiple heaters/dryers.

To remove additional excess moisture if needed, the gypsum panel may be dried at a drying temperature. The drying temperature may be at least about 170° F. but less than or equal to about 550° F., and in some embodiments the heating temperature may be between about 350° F. and about 450° F. For instance, the heating temperature may have a lower bound that is at least about 170° F., 180° F., 190° F., 200° F., 210° F., 220° F., 230° F., 240° F., 250° F., 260° F., 270° F., 280° F., 290° F., 300° F., 310° F., 320° F., 330° F., 340° F., 350° F., 360° F., 370° F., 380° F., 390° F., 400° F., 410° F., 420° F., 430° F., 440° F., 450° F., 460° F., 470° F., 480° F., 490° F., 500° F., 510° F., 520° F., 530° F., or 540° F., in combination with an upper bound that is greater than the lower bound and at most about 550° F., 540° F., 530° F., 520° F., 510° F., 500° F., 490° F., 480° F., 470° F., 460° F., 450° F., 440° F., 430° F., 420° F., 410° F., 390° F., 380° F., 370° F., 360° F., 350° F., 340° F., 330° F., 320° F., 310° F., 300° F., 290° F., 280° F., 270° F., 260° F., 250° F., 240° F., 230° F., 220° F., 210° F., 200° F., 190° F., or 180° F. Drying may take place in a single stage or in multiple stages, each of which may occur at heating temperatures in the ranges disclosed above.

Sizes of the wallboard panel can vary as needed. Example areas for the cut panels can be m×n, where m is any width between about 4 ft and about 6 ft, and n is any length between about 8 ft and about 20 ft. A nonlimiting example size for the dried wallboard panel is about 4 ft×12 ft. Example thicknesses for the dried wallboard panel are between about ⅜ inches and about ¾ inches.

Experiments

In comparative experiments according to some embodiments, uncooked starch (Ecosol 45, ADM) was added into a pulp stock at 0%, 3%, and 6% (dry pulp basis), respectively. The pulp stock was then sheeted, formed, pressed, and dried at a drum dryer (at 225° F.) to form a lab handsheet. The properties of the example handsheets are listed in Table 1, below.

The handsheet samples were conditioned to 70° F. and 50%±2% humidity for 24 hours. Caliper was measured using the TECHNIDYNE™ PROFILE/PLUS™ Caliper Tester by placing the sample inside the tester to measure the thickness of the sample according to Tappi Standard T-411. Porosity was measured using the TECHNIDYNE™ PROFILE/PLUS™ Porosity Tester by placing the sample inside the tester to measure the permeability of air according to Tappi Standard T-460.

Tensile strength was tested according to a modified Tappi Standard T-494. The samples were conditioned at 150° F. for 10 minutes. Each paper sample was cut to a dimension of 4 inches long and 2 inches wide. The sample was placed into a Thwing-Albert Tensile Tester using a gap distance between the clamps of 2 inches. The Thwing-Albert Tensile Tester was used to measure the tensile strength (ultimate strength) of the paper at a rate of 2 inches per minute. Increases in the tensile strength indicate improvement in the strength of the paper.

TABLE 1

| | Control | | |
|---|---|---|---|
| | Handsheet A | Handsheet A | Handsheet B |
| Starch (%, dry pulp | 0 | 3 | 6 |
| basis) | | | |
| Base weight (lb/msf) | 43.4 | 44.9 | 45.4 |
| Retention (%) | 91 | 91 | 90 |
| Caliper (mils) | 17.7 | 18.2 | 17.2 |
| Porosity (sec) | 5.1 | 6.7 | 7.1 |
| Tensile strength (lbf) | 59.6 | 72.9 | 78.7 |
| Nail pull strength (lb) | 85.2 | 86.4 | 93.3 |

Lab wallboard samples (6 inch×9 inch) with the prepared handsheets as face paper were prepared according the formulation listed in Table 2.

The stucco slurry was soaked for 10 seconds and mixed in a Waring Blender at high speed for 10 seconds. The slurry was then transferred into a paper envelop. After the slurry set, the sample was heated at 440° F. for 9 min, followed by 380° F. for another 21 min. The nail pull strength of the lab wallboard sample was tested according to ASTM 473-10. A 7/64″ diameter pilot hole was drilled through the specimen at the center on face side. The dried specimen was conditioned to a constant weight at 75° F.±2° F. and 50%±2% relative humidity. Insert a test “nail” into the pilot hole. The nail shank has a diameter of 0.099″±0.003″ and the nail head has a diameter of 0.250″±0.005″. An ATS Applied Test System was used to measure the nail pull strength at a uniform load speed of 1″ per minute. Nail pull strength results for the handsheets are listed in Table 1.

TABLE 2

| | |
|---|---|
| WSR (Water-stucco ratio) | 1.90 |
| Stucco (g) | 250 |
| Accelerator (g) | 2.5 |
| Pregelatinized starch (g) | 2.5 |
| Sodium trimetaphosphate 10% solution (g) | 5.0 |
| Dispersant (g) | 1.25 |
| Retarder 1% solution (g) | 4.75 |
| Water (g) | 464 |

Table 1 shows that 3% of the starch addition increased tensile strength from 59.6 lbf to 72.9 lbf, a 22% increase. Six percent of the starch addition increased tensile strength from 59.6 lbf to 78.7 lbf, a 32% increase. However, 3% of starch addition did not increase nail pull strength. Surprisingly and unexpectedly, 6% of the starch addition increased nail pull strength from 85.3 lbs to 93.3 lbs, a significant increase of 8.1 lbs.

Complete gelatinization of the starch in the handsheet is useful for strength improvement. When the experimental handsheet was dried with a short time (40 seconds compared to 60 seconds), nail pull strength improvement was not significant (Table 3). This might have been caused by incomplete gelatinization of the starch. Moisture of the pressed sheet was driven off from the sheet too fast.

Nail pull strength was improved by partial pre-cooking of the starch. One part of the starch was premixed with 9 parts of water preheated to 140 F. The partially preheated starch slurry was added into pulp stock to make the handsheet. Table 4 shows addition of 6% of partially pre-cooked starch increased tensile strength by 39% and nail pull strength by 8.3 lbs.

TABLE 3

| | Control Handsheet B | Handsheet C |
|---|---|---|
| Starch (%, dry pulp | 0 | 6 |
| basis) | | |
| Tensile strength (lbf) | 75.9 | 84.4 |
| Nail pull strength (lb) | 92.6 ± 5.6 | 95.2 ± 6.4 |

TABLE 4

| | Control Handsheet C | Handsheet D |
|---|---|---|
| Starch (%, dry pulp | 0 | 6 (partially precooked) |
| basis) | | |
| Tensile strength (lbf) | 54.5 | 75.7 |
| Nail pull strength | 87.2 ± 2.5 | 95.5 ± 2.1 |

Two uncooked cationic starches (CATO™ 232 and OPTIPRO™ 650 from Ingredion Incorporated (Westchester, Ill.)) were added into a pulp stock at 6% (dry pulp basis), respectively. The pulp stock was then made into lab handsheets. The properties of the handsheets are listed in Table 5, below.

The handsheets including uncooked cationic starches (6%) had similar tensile strength and nail pull strength to those including uncooked anionic starch (Ecosol 45). However, the cationic starches increased the total pulp stock retention.

TABLE 5

| | Control | Handsheet | Handsheet | Handsheet |
|---|---|---|---|---|
| | Handsheet D | E | F | G |
| Starch (%, dry | N/A | Ecosol 45(6) | Cato 232 (6) | OptiPro (6) |
| pulp basis) | | | | |
| Base weight | 40.1 | 41.6 | 43.3 | 44.6 |
| (lb/msf) | | | | |
| Retention (%) | 88.2 | 86.8 | 90.3 | 93.1 |
| Tensile | 49.2 | 67.7 | 71.6 | 67.9 |
| strength (lbf) | | | | |
| Nail pull | 85.6 | 92.4 | 93 | 93.5 |
| strength (lb) | | | | |

Embodiments disclosed herein provide, among other things, a gypsum wallboard panel comprising: a gypsum core; and a paper cover sheet disposed on the gypsum core, the paper cover sheet comprising pulp fiber and an uncooked starch in an amount of at least 2% by weight of the pulp fiber. In addition to any of the above features in this paragraph, the paper cover sheet may be a multi-ply paper cover sheet, and at least one of the plies may include the uncooked starch. In addition to any of the above features in this paragraph, the multi-ply cover sheet may include at least one filler ply and at least one liner ply, and at least one of the filler ply or the liner ply may include the uncooked starch. In addition to any of the above features in this paragraph, the paper cover sheet may comprise manila paper. In addition to any of the above features in this paragraph, the gypsum core may comprise a back side and a face side, and the paper cover sheet may at least partially cover the face side and/or the back side of the gypsum core. In addition to any of the above features in this paragraph, the gypsum core may comprise a back side and a face side, wherein the paper cover sheet may at least partially cover the face side of the gypsum core, and wherein the gypsum wallboard panel may further comprise an additional paper cover sheet at least partially covering the back side of the gypsum core. In addition to any of the above features in this paragraph, the uncooked starch in the paper cover sheet may be provided in an amount of at least 3% by weight of the pulp fiber. In addition to any of the above features in this paragraph, the uncooked starch in the paper cover sheet may be provided in an amount of at least 6% by weight of the pulp fiber. In addition to any of the above features in this paragraph, the uncooked starch in the paper cover sheet may be provided in an amount between 2% and 10% by weight of the pulp fiber. In addition to any of the above features in this paragraph, the uncooked starch may comprise one or more of an anionic starch, a cationic starch, or an uncharged starch. In addition to any of the above features in this paragraph, the pulp fiber may comprise hard stock or soft stock fiber. In addition to any of the above features in this paragraph, the pulp fiber may comprise one or more of Kraft paper, corrugated paper, cellulose fibers, waste newsprint, microfibrillated cellulose, or any combination thereof. In addition to any of the above features in this paragraph, the wallboard panel may have a nail pull resistance at least about 6 lbs greater than a nail pull resistance of an equivalent wallboard panel without the uncooked starch, and/or a reduced density of between 6 to 10 lbs per msf. In addition to any of the above features in this paragraph, the wallboard panel may have a tensile strength of at least 20%-40% greater than a tensile strength of an equivalent wallboard panel without the uncooked starch.

Additional embodiments disclosed herein provide, among other things, a multi-ply paper cover sheet comprising: a plurality of plies, at least one ply comprising: pulp fiber comprising one or more of hard stock or soft stock fiber; and an uncooked starch in an amount of at least 2% by weight of the pulp fiber. In addition to any of the above features in this paragraph, the plurality of plies comprise at least one filler layer and at least one liner layer. In addition to any of the above features in this paragraph, at least two of the plies may comprise the pulp fiber and the uncooked starch. In addition to any of the above features in this paragraph, the pulp fiber may comprise one or more of Kraft paper, corrugated paper, cellulose fibers, waste newsprint, microfibrillated cellulose, or any combination thereof.

Additional embodiments disclosed herein provide, among other things, a composition for a paper cover sheet comprising: water; pulp fiber comprising one or more of hard stock or soft stock fiber; and an uncooked starch in an amount of at least 2% by weight of the pulp fiber. In addition to any of the above features in this paragraph, the pulp fiber may comprise one or more of Kraft paper, corrugated paper, cellulose fibers, waste newsprint, microfibrillated cellulose, or any combination thereof.

Additional embodiments disclosed herein provide, among other things, a method for making a paper cover sheet for a wallboard, the method comprising: preparing a composition comprising water and pulp fiber comprising one or more of hard stock or soft stock fiber; incorporating an uncooked starch in an amount of at least 2% by weight of the pulp fiber into the composition; forming at least one ply with the composition; and drying the at least one ply. In addition to any of the above features in this paragraph, the incorporating may comprise combining the uncooked starch with the composition before the forming. In addition to any of the above features in this paragraph, the incorporating may comprise mixing the uncooked starch with the composition in a liquid mixture. In addition to any of the above features in this paragraph, the incorporating may comprise combining the uncooked starch with the composition after the forming. In addition to any of the above features in this paragraph, the incorporating may comprise: combining the uncooked starch with water; and dispersing the combined uncooked starch and water onto the formed at least one ply to migrate through the formed at least one ply. In addition to any of the above features in this paragraph, the method may further comprise preheating the uncooked starch in the combined uncooked starch and water to a temperature above ambient temperature and below a pregelatinization temperature of the uncooked starch to allow the water to penetrate starch granules of the uncooked starch. Additional embodiments disclosed herein provide, among other things, a paper cover sheet prepared according to any of the methods in this paragraph.

Additional embodiments disclosed herein provide, among other things, a method of forming a wallboard panel comprising: preparing a paper cover sheet according to any of the methods in the previous paragraph; preparing a gypsum slurry comprising gypsum and water; forming a gypsum core layer over the prepared paper cover sheet; allowing the gypsum core layer to set; and drying the gypsum core layer. In addition to any of the above features in this paragraph, the prepared paper cover sheet may be disposed in one or more paper rolls and fed to a conveyor belt; and the gypsum core layer may be formed by dispensing the gypsum slurry over the prepared paper cover sheet as it moves along the conveyor belt. In addition to any of the above features in this paragraph, the method may further comprise: preparing an additional cover sheet; and covering the formed gypsum core layer with the prepared additional cover sheet. In addition to any of the above features in this paragraph, the prepared paper cover sheet may comprise manila paper. In addition to any of the above features in this paragraph, the prepared additional paper cover sheet may be other than manila paper. Additional embodiments disclosed herein provide, among other things, a gypsum wallboard prepared according to any of the methods in this paragraph.

Additional embodiments disclosed herein provide, among other things, a paper cover sheet as described herein.

Additional embodiments disclosed herein provide, among other things, a gypsum panel as described herein.

General

The foregoing description is merely illustrative in nature and is in no way intended to limit the disclosure, its application, or uses. The broad teachings of the disclosure may be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure may be implemented in and/or combined with features of any of the other embodiments, even if that combination is not explicitly described. It will be readily understood that the aspects of the present disclosure, as generally described herein, and illustrated in the figures, can be arranged, substituted, combined, separated, and designed in a wide variety of different configurations, all of which are explicitly contemplated herein. In other words, the described embodiments are not mutually exclusive, and permutations of one or more embodiments with one another remain within the scope of this disclosure. Other embodiments may be utilized, and other changes may be made, without departing from the scope of the subject matter presented herein.

Any of the above aspects and embodiments can be combined with any other aspect or embodiment as disclosed here in the Summary, Figures and/or Detailed Description sections, except where such combinations would be infeasible as will be appreciated by an artisan.

As used in this specification and the claims, the singular forms “a,” “an” and “the” include plural referents unless the context clearly dictates otherwise.

Unless specifically stated or obvious from context, as used herein, the term “or” is understood to be inclusive and covers both “or” and “and.”

Unless specifically stated or obvious from context, as used herein, the term “about” is understood as within a range of normal tolerance in the art, for example within 2 standard deviations of the mean. About can be understood as within 20%, 19%, 18%, 17%, 16%, 15%, 14%, 13%, 12%, 11%, 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Unless specifically stated or obvious from context, as used herein, the terms “substantially all”, “substantially most of”, “substantially all of” or “majority of” encompass at least about 90%, 95%, 97%, 98%, 99% or 99.5%, or more of a referenced amount of a composition.

The entirety of each patent, patent application, publication and document referenced herein hereby is incorporated by reference. Citation of the above patents, patent applications, publications and documents is not an admission that any of the foregoing is pertinent prior art, nor does it constitute any admission as to the contents or date of these publications or documents. Incorporation by reference of these documents, standing alone, should not be construed as an assertion or admission that any portion of the contents of any document is considered to be essential material for satisfying any national or regional statutory disclosure requirement for patent applications. Notwithstanding, the right is reserved for relying upon any of such documents, where appropriate, for providing material deemed essential to the claimed subject matter by an examining authority or court.

Modifications may be made to the foregoing without departing from the basic aspects of the invention. Although the invention has been described in substantial detail with reference to one or more specific embodiments, those of ordinary skill in the art will recognize that changes may be made to the embodiments specifically disclosed in this application, and yet these modifications and improvements are within the scope and spirit of the invention. The invention illustratively described herein suitably may be practiced in the absence of any element(s) not specifically disclosed herein. Thus, for example, in each instance herein any of the terms “comprising”, “consisting essentially of”, and “consisting of” may be replaced with either of the other two terms. Thus, the terms and expressions which have been employed are used as terms of description and not of limitation, equivalents of the features shown and described, or portions thereof, are not excluded, and it is recognized that various modifications are possible within the scope of the invention. Embodiments of the invention are set forth in the following claims.

It will be appreciated that variations of the above-disclosed embodiments and other features and functions, or alternatives thereof, may be desirably combined into many other different systems or applications. Also, various presently unforeseen or unanticipated alternatives, modifications, variations, or improvements therein may be subsequently made by those skilled in the art which are also intended to be encompassed by the description above and the following claims.

What is claimed is:

1. A gypsum wallboard panel comprising:
a. a gypsum core; and
b. a paper cover sheet disposed on the gypsum core, the paper cover sheet comprising pulp fiber and an uncooked starch in an amount of at least 2% by weight of the pulp fiber.

2. The gypsum wallboard panel of claim 1, wherein the paper cover sheet is a multi-ply paper cover sheet, and wherein at least one of the plies includes the uncooked starch.

3. The gypsum wallboard panel of claim 2, wherein the multi-ply cover sheet includes at least one filler ply and at least one liner ply, and wherein at least one of the filler ply or the liner ply includes the uncooked starch.

4. The gypsum wallboard panel of claim 1, wherein the paper cover sheet comprises manila paper.

5. The gypsum wallboard panel of claim 1, wherein the gypsum core comprises a back side and a face side, and wherein the paper cover sheet at least partially covers the face side and/or the back side of the gypsum core.

6. The gypsum wallboard panel of claim 1, wherein the gypsum core comprises a back side and a face side, wherein the paper cover sheet at least partially covers the face side of the gypsum core, and wherein the gypsum wallboard panel further comprises an additional paper cover sheet at least partially covering the back side of the gypsum core.

7. The gypsum wallboard panel of claim 1, wherein the uncooked starch in the paper cover sheet is provided in an amount of at least 3% by weight of the pulp fiber.

8. The gypsum wallboard panel of claim 1, wherein the uncooked starch in the paper cover sheet is provided in an amount of at least 6% by weight of the pulp fiber.

9. The gypsum wallboard panel of claim 1, wherein the uncooked starch in the paper cover sheet is provided in an amount between 2% and 10% by weight of the pulp fiber.

10. The gypsum wallboard panel of claim 1, wherein the uncooked starch comprises one or more of an anionic starch, a cationic starch, or an uncharged starch.

11. The gypsum wallboard panel of claim 1, wherein the pulp fiber comprises hard stock or soft stock fiber.

12. The gypsum wallboard panel of claim 1, wherein the pulp fiber comprises one or more of Kraft paper, corrugated paper, cellulose fibers, waste newsprint, microfibrillated cellulose, or any combination thereof.

13. The gypsum wallboard panel of claim 1, wherein the wallboard panel has a nail pull resistance at least about 6 lbs greater than a nail pull resistance of an equivalent wallboard panel without the uncooked starch, and/or a reduced density of between 6 to 10 lbs per msf.

14. The gypsum wallboard panel of claim 1, wherein the wallboard panel has a tensile strength of at least 20%-40% greater than a tensile strength of an equivalent wallboard panel without the uncooked starch.

15. A multi-ply paper cover sheet comprising:
a. a plurality of plies, at least one ply comprising:
i. pulp fiber comprising one or more of hard stock or soft stock fiber; and
ii. an uncooked starch in an amount of at least 2% by weight of the pulp fiber.

16. The multi-ply cover sheet of claim 15, wherein the plurality of plies comprise at least one filler layer and at least one liner layer.

17. The multi-ply cover sheet of claim 15 wherein at least two of the plies comprise the pulp fiber and the uncooked starch.

18. The multi-ply cover sheet of claim 15, wherein the pulp fiber comprises one or more of Kraft paper, corrugated paper, cellulose fibers, waste newsprint, microfibrillated cellulose, or any combination thereof.

19. A composition for a paper cover sheet comprising:
a. water;
b. pulp fiber comprising one or more of hard stock or soft stock fiber; and
c. An uncooked starch in an amount of at least 2% by weight of the pulp fiber.

20. The composition of claim 19, wherein the pulp fiber comprises one or more of Kraft paper, corrugated paper, cellulose fibers, waste newsprint, microfibrillated cellulose, or any combination thereof.

21. A method for making a paper cover sheet for a wallboard, the method comprising:
a. preparing a composition comprising water and pulp fiber comprising one or more of hard stock or soft stock fiber;
b. incorporating an uncooked starch in an amount of at least 2% by weight of the pulp fiber into the composition;
c. forming at least one ply with the composition; and
d. drying the at least one ply.

22. The method of claim 21, wherein said incorporating comprises combining the uncooked starch with the composition before said forming.

23. The method of claim 22, wherein said incorporating comprising mixing the uncooked starch with the composition in a liquid mixture.

24. The method of claim 21, wherein said incorporating comprises combining the uncooked starch with the composition after said forming.

25. The method of claim 24, wherein said incorporating comprises:
a. combining the uncooked starch with water; and
b. dispersing the combined uncooked starch and water onto the formed at least one ply to migrate through the formed at least one ply.

26. The method of claim 25, wherein the method further comprises preheating the uncooked starch in the combined uncooked starch and water to a temperature above ambient temperature and below a pregelatinization temperature of the uncooked starch to allow the water to penetrate starch granules of the uncooked starch.

27. A method of forming a wallboard panel comprising:
a. preparing a paper cover sheet according to the method of claim 21;
b. preparing a gypsum slurry comprising gypsum and water;
c. forming a gypsum core layer over the prepared paper cover sheet;
d. allowing the gypsum core layer to set; and
e. drying the gypsum core layer.

28. The method of claim 27,
a. wherein the prepared paper cover sheet is disposed in one or more paper rolls and fed to a conveyor belt; and
b. wherein the gypsum core layer is formed by dispensing the gypsum slurry over the prepared paper cover sheet as it moves along the conveyor belt.

29. The method of claim 27, wherein the method further comprises:
a. preparing an additional cover sheet; and
b. covering the formed gypsum core layer with the prepared additional cover sheet.

30. The method of claim 29, wherein the prepared paper cover sheet comprises manila paper.

31. The method of claim 29, wherein the prepared additional paper cover sheet is other than manila paper.

32. A paper cover sheet prepared according to the method of claim 21.

33. A gypsum wallboard prepared according to the method of claim 27.

34. A paper cover sheet as described herein.

35. A gypsum panel as described herein.
